(19) United States
(12) Patent Application Publication
(10) Pub. No.: US 2023/0272886 A1
(43) Pub. Date: Aug. 31, 2023

(54) LAMP SCREW CAP

(71) Applicant: SIGNIFY HOLDING B.V., EINDHOVEN (NL)

(72) Inventors: LIESBET HILLECHINA WIND, GELDROP (NL); IVO MARIA MARTINUS DURLINGER, GELDROP (NL)

(21) Appl. No.: 18/018,118

(22) PCT Filed: Jul. 16, 2021
(86) PCT No.: PCT/EP2021/069939

§ 371 Date: Jan. 26, 2023

(30) Foreign Application Priority Data
Jul. 27, 2020 (EP) 20187840.2

(51) Int. Cl. F21K 9/235; F16B 33/02

(52) U.S. Cl. CPC F21K 9/235; F16B 33/02

(57) ABSTRACT

The invention provides a lamp screw cap (200) comprising a thread structure (220), wherein the thread structure (220) comprises repetitive elements (225) defining tops (230), valleys (240), and a central plane (250), wherein tops (230) protrude relative to the central plane (250) and wherein the valleys (240) are recessed relative to the central plane (250), wherein: for a plurality of tops (230) applies that each top (230) comprises a first top segment (231), a second top segment (232), and a middle top segment (233), together defining the top (230), wherein the middle top segment (233) is configured most remote from the central plane (250); for a plurality of valleys (240) applies that each valley (240) comprises a first valley segment (241), a second valley segment (242), and a middle valley segment (243), together defining the valley (240), wherein the middle valley segment (243) is configured most remote from the central plane (250); the first top segment (231), the second top segment (232), the first valley segment (241), and the second valley segment (242), have the same first curvature; one or more of the following applies: the plurality of tops (230) have a protruding part (235) protruding relative to the first curvature in a direction away from the central plane (250); and the plurality of valleys (240) have a shallow part (245) receding relative to the first curvature in a direction to the central plane (250).

### FIELD OF THE INVENTION

The invention relates to a lamp screw cap. The invention further relates to a lamp comprising such screw cap. The invention further relates to a street lamp comprising such lamp. The invention further relates to a process for the production of a lamp screw cap.

### BACKGROUND OF THE INVENTION

Lamp elements for reducing vibration impact are known in the art. For instance, US2013077325 describes a dampener configured to augment the mounting of a lamp in a socket by resisting displacement of the lamp relative to the socket. The dampener is made from a material able to absorb vibrations and to reduce or prevent vibrations in the lamp. The dampener is made in one piece or more pieces, wherein each piece is interposable in whole or in part between the socket and the lamp base to insulate the lamp in whole or part against the vibration translated through the socket or surrounding air.

U.S. Pat. No. 1,969,641 A discloses an improvement in screw caps for electric lamps to be screwed into a threaded lamp socket. In screw caps for electric lamps to be screwed into threaded lamp sockets, a device for locking the cap in the socket and securing the electrical contact between said members, consisting in at least one hollow resilient projection from the bottom of the thread of the crew cap, said projection being, in the longitudinal direction of the thread, of an elongated shape and provided with a sloping side adapted to be pressed with wedge action against the bottom of the thread of the socket, when the lamp is screwed into the socket, and to effect locking by friction due to elastic deformation of said projection.

### SUMMARY OF THE INVENTION

Heavy and/or big lamps, such as high lumen LED lamps, may be sensitive to vibration loads, which may be especially critical in outdoor applications where strong winds can occur. Similarly, horizontally, base down, and base up placed lamps may be sensitive to vibration loads.

Vibration loads may result in various failure modes for a lamp. For example, the vibration loads may result in the lamp loosening from a holder, the holder getting damaged, and/or the lamp screw cap getting damaged. Even, the lamp may get loose from the fitting.

However, prior art lamp screw caps (and/or holders) accounting for one failure mode may generally increase the odds of a different failure, thereby being limited in the overall reduction of the failure rate. For example, if a lamp is inserted in a holder loosely, the lamp may fall out as a result of vibrations; when the lamp is inserted more tightly instead, the vibrations may damage the holder (or the cap) instead of loosening the lamp.

Hence, it is an aspect of the invention to provide an alternative lamp screw cap, which preferably further at least partly obviates one or more of above-described drawbacks. The present invention may have as object to overcome or ameliorate at least one of the disadvantages of the prior art, or to provide a useful alternative.

Hence, in a first aspect, the invention provides a lamp screw cap comprising a thread structure. The thread structure may comprise repetitive elements defining tops and valleys. The thread structure may further define a (virtual) central plane, especially wherein tops protrude relative to the central plane and wherein the valleys are recessed relative to the central plane. In particular, in a cross-sectional view of the thread structure, especially parallel to a longitudinal dimension of the lamp cap screw, the tops may protrude relative to the central plane and the valleys may be recessed relative to the central plane. In embodiments, for a plurality of tops may apply that each top comprises a first top segment, a second top segment, and a middle top segment. The first top segment, the second top segment and the middle top segment may especially together define the top. In particular, the middle top segment may be configured most remote from the central plane. Similarly, in embodiments, for a plurality of valleys may apply that each valley comprises a first valley segment, a second valley segment, and a middle valley segment. The first valley segment, the second valley segment and the middle valley segment may especially together define the valley. In particular, the middle valley segment may be configured most remote from the central plane. In embodiments, in a cross-sectional view an outline of the thread structure has a shape approximating a periodic structure. The periodic structure may have a regular periodicity and a regular amplitude with respect to the central plane. In further embodiments, one or more of the first top segment, the second top segment, the first valley segment, and the second valley segment may define at least part of the periodic structure. Especially, the first top segment, the second top segment, the first valley segment, and the second valley segment may (all) define at least part of the periodic structure. In embodiments, one or more of the following may apply: (i) one or more, especially a plurality, of tops have a protruding part, especially a protruding part protruding relative to the periodic structure in a direction away from the central plane; and (ii) one or more, especially a plurality, of valleys have a shallow part, especially a shallow part receding relative to the periodic structure in a direction to the central plane. Hence, in specific embodiments, the invention provides a lamp screw cap comprising a thread structure, wherein the thread structure comprises repetitive elements defining tops, valleys, and a central plane, wherein tops protrude relative to the central plane and wherein the valleys are recessed relative to the central plane, wherein: for a plurality of tops applies that each top comprise a first top segment, a second top segment, and a middle top segment, together defining the top, wherein the middle top segment is configured most remote from the central plane; for a plurality of valleys applies that each valley comprise a first valley segment, a second valley segment, and a middle valley segment, together defining the valley, wherein the middle valley segment is configured most remote from the central plane; in a cross-sectional view an outline of the thread structure has a shape approximating a periodic structure with a regular periodicity and amplitude, and wherein the first top segment, the second top segment, the first valley segment, and the second valley segment define at least part of the periodic structure; one or more of the following applies: (i) the plurality of tops have a protruding part protruding relative to the periodic structure in a direction away from the central plane; and (ii) the plurality of valleys have a shallow part receding relative to the periodic structure in a direction to the central plane.

Such lamp screw cap may allow having the lamp more stable fixed in the fitting. With the deviations in the form of the protruding parts and/or the shallow parts, the screw cap may be more tight in the fitting. Hence, vibration load may be better managed and the lifetime of the lamp may (thereby) increased.

In particular, the thread structure may have a shape defined by circle segments (or “circular segments”), especially circle segments with constant radii, such as by a plurality of (connected) semicircles. Hence, in specific embodiments, the invention may provide a lamp screw cap comprising a thread structure, wherein the thread structure comprises repetitive elements defining tops, valleys, and a (virtual) central plane, wherein tops protrude relative to the central plane and wherein the valleys are recessed relative to the central plane, wherein: for a plurality of tops applies that each top comprises a first top segment, a second top segment, and a middle top segment, together defining the top, wherein the middle top segment is configured most remote from the central plane; for a plurality of valleys applies that each valley comprise a first valley segment, a second valley segment, and a middle valley segment, together defining the valley, wherein the middle valley segment is configured most remote from the central plane; the first top segment, the second top segment, the first valley segment, the second valley segment, have the same first curvature; one or more of the following applies: the plurality of tops have a protruding part protruding relative to the first curvature in a direction away from the central plane; and the plurality of valleys have a shallow part receding relative to the first curvature in a direction to the central plane.

In embodiments, the thread structure may have a shape defined by circle segments, wherein the circle segments have independently selected arcs from the range of 0°-180°. In embodiments, the circular arcs may be at least 60°, such as at least 80°, especially at least 100°, such as at least 120°, especially at least 140°. In further embodiments, the circular arcs may be at most 175°, such as at most 170°, especially at most 160°, such as at most 150°, especially at most 140°.

The invention will herein for explanatory purposes primarily be described with respect to embodiments wherein the thread structure has a shape defined by semicircles. It will, however, be clear to the person skilled in the art that the thread structure may also have a different shape, such as a shape defined by circle segments.

As indicated above, the lamp screw cap as described herein may provide the benefit that lamps with a higher vibration tolerance may be obtained. In particular, the lamp screw caps may, when connected (or “screwed in”) to a fitting, be more stable with regards to vibrations. Hence, the lamp screw caps may reduce the failure rate of lamps exposed to vibrations, especially of large lamps. In particular, the invention may relate to the insight that vibration strength may partially depend on the lamp cap thread diameter, wherein a larger cap may give a better fixed interface and a lower vibration failure rate. Hence, the lamp cap thread diameter may be selected to (essentially) be the maximally allowable lamp cap thread diameter for a particular standard. Further, adding a (pointed) rim on the tops and/or valleys of the thread structure was observed to further benefit the vibration strength. Similarly, adding a planar valley part in a valley of the thread structure may also benefit the vibration strength.

Hence, the invention may provide a lamp screw cap comprising a thread structure. The lamp screw cap may be functionally couplable with a light source, especially a lamp bulb, to provide a lamp. The thread structure may especially facilitate screwing the lamp screw cap into a lamp fitting. Hence, the herein described lamp may include the lamp screw cap and a light source.

The thread structure may comprise repetitive elements. The repetitive elements may define tops, valleys, and a (virtual) central plane, especially wherein the tops protrude relative to the central plane and wherein the valleys are recessed relative to the central plane. In particular, in a cross-section of the thread structure (parallel to a longitudinal axis of the lamp screw cap) the tops may protrude relative to the central plane and the valleys may be recessed relative to the central plane. The central plane may especially be configured essentially equidistant to a tip of the tops and a bottom of the valleys. Alternatively, the central plane may divide the valleys and the tops.

In particular, different cross-sections may each provide a respective central plane, wherein the central planes together define a virtual cylinder from which the tops of the thread structure protrude and into which the valleys of the thread structure recess.

In embodiments, for a plurality of tops may apply that each top comprises a first top segment, a second top segment, and a middle top segment. Hence, each top of a plurality of tops comprises a first top segment, a second top segment, and a middle top segment. The first top segment, the second top segment and the middle top segment are especially non-overlapping. In embodiments, the first top segment, the second top segment and the middle top segment may together define the top. The middle top segment may be configured most remote from the central plane. Hence, the first top segment and the second top segment may be arranged between the central plane and the middle top segment. Especially, the first top segment (and the second top segment) may span from the central plane to the middle top segment.

Similarly, for a plurality of valleys may apply that each valley comprises a first valley segment, a second valley segment, and a middle valley segment. Hence, each valley of a plurality of valleys comprises a first valley segment, a second valley segment, and a middle valley segment. The first valley segment, the second valley segment and the middle valley segment are especially non-overlapping. In embodiments, the first valley segment, the second valley segment and the middle valley segment may together define the valley. The middle valley segment may be configured most remote from the central plane. Hence, the first valley segment and the second valley segment may be arranged between the central plane and the middle valley segment. Especially, the first valley segment (and the second valley segment) may span from the central plane to the middle valley segment.

In embodiments, in a cross-sectional view an outline of (at least part of) the thread structure has a shape approximating a periodic structure with a regular periodicity and amplitude. In particular, in a cross-sectional view of the thread structure, an outline of the thread structure at one side of the longitudinal axis may have a shape approximating a periodic structure with a regular periodicity and amplitude.

The term “regular” with regards to periodicity and amplitude may especially refer to the periodicity/amplitude being substantially constant. Hence, for example, periods of a periodic structure with a regular periodicity may have a constant period length for at least 50% of the periodic structure, such as for at least 70%, especially at least 80%, such as for at least 90%, including 100%. Similarly, the amplitudes of a periodic structure with a regular amplitude may have a constant length (relative to the central plane) for at least 50% of the periodic structure, such as for at least 70%, especially at least 80%, such as for at least 90%, including 100%.

The term “approximate” and its conjugations herein, such as in “to approximate a shape”, refers to being nearly identical to, especially identical to, the following term, for example nearly identical to a periodic structure, such as nearly identical to a periodic structure defined by connected semicircles, or such as nearly identical to a periodic structure defined by a sine wave. For example, in a cross-section an outline of the thread structure may define a sine wave but for a minor deviation, such as a protruding part in a top and/or a shallow part in a valley. Similarly, for example, in the cross-section the outline of the thread structure may define a periodic structure comprising a plurality of semicircles but for a local deviation in (first) curvature, especially a local deviation in curvature due to a protruding part in a top and/or a shallow part in a valley. Hence, the periodic structure may be a dominant shape of the outline, but the outline may have a deviation with respect to the shape, especially wherein the deviation comprises a protruding part in a top and/or a shallow part in a valley. In particular, an outline approximating a first shape may herein refer to: a first shape realization corresponding to a best fit of the first shape to the outline, such as a first shape realization obtained via a least squares fit, wherein a deviation between the outline and the first shape realization is at each location along the outline at most 1 mm, especially at most 0.5 mm, such as at most 0.3 mm, especially at most 0.1 mm.

In embodiments, the first top segment, the second top segment, the first valley segment, and/or the second valley segment may define at least part of the periodic structure. In particular, the first top segment, the second top segment, the first valley segment, and the second valley segment may essentially match the periodic structure, wherein the middle top segment and/or the middle valley segment may deviate from the periodic structure.

Hence, in further embodiments, a top of the plurality of tops may have a protruding part protruding relative to the periodic structure in a direction away from the central plane (or: “away from the longitudinal axis”). Especially, a plurality of tops may have a protruding part protruding relative to the periodic structure in a direction away from the central plane.

In further embodiments, a valley of the plurality of valleys may have a shallow part receding relative to the periodic structure in a direction to the central plane (or: “to the longitudinal axis”). Especially, a plurality of tops may have a protruding part protruding relative to the periodic structure in a direction away from the central plane.

The protruding part and/or the shallow part may result in a higher vibration strength when providing a connection between the lamp screw cap and a lamp fitting, i.e., such embodiments of the lamp screw cap may, when connected to a lamp fitting, provide a higher vibration strength, resulting in a reduced failure rate when corresponding lamps are exposed to vibrations.

The local deviation from the periodic structure at the middle top segment and/or the middle valley segment may provide an improved performance relative to a deviation spanning across the entire top and/or valley, as well as to a local deviation from the periodic structure at the first top segment, the second top segment, the first valley segment and/or the second valley segment. In particular, by increasing the top size and/or reducing the bottom size, such as tops with an increased first curvature and valleys with a reduced first curvature relative to a standard lamp screw cap may result in a tight fit into a fitting, but the tight fit may not reduce the failure rate due to vibrations to the same extent as the herein described local deviations at middle top segments and/or middle valley segments.

Hence, in embodiments, the periodic structure may define a dominant shape of the outline, but the outline may have a deviation with respect to the shape, especially wherein the deviation comprises a protruding part in a top and/or a shallow part in a valley.

In embodiments, the periodic structure may be defined by a plurality of circular arcs, especially by a plurality of semicircles, especially wherein adjacent semicircles are arranged at alternating sides of the central plane, and especially wherein the adjacent semicircles abut at the central plane, and especially wherein the adjacent semicircles form a continuous structure.

Hence, in further embodiments, the first top segment, the second top segment, the first valley segment, the second valley segment, may have the same first curvature. Hence, the first top segment, the second top segment, the first valley segment, and the second valley segment may each define at least part of a semicircle (with radius of curvature r).

In such embodiments, a top of the plurality of tops, especially a plurality of tops, may have a protruding part protruding relative to the first curvature in a direction away from the central plane, i.e., the (first curvature of the) first top segment and the second top segment may define at least part of a semicircle (with radius r), wherein the top of the plurality of tops, especially a plurality of tops, has a protruding part protruding relative to the semicircle in a direction away from the central plane.

In further embodiments, the first valley segment, the second valley segment, the first valley segment, and the second valley segment, may have the same first curvature. Hence, the first valley segment, the second valley segment, the first valley segment, and the second valley segment may each define at least part of a semicircle (with radius (r)).

In such embodiments, a valley of the plurality of valleys, especially a plurality of valleys, may have a shallow part receding relative to the first curvature in a direction to the central plane, i.e., the (first curvature of the) first valley segment and the second valley segment may define at least part of a semicircle (with radius of curvature r), wherein the valley of the plurality of valleys, especially a plurality of valleys, has a shallow part receding relative to the semicircle in a direction to the central plane.

In further embodiments, the periodic structure may have a shape defined by a sine wave. Especially, the periodic structure may comprise a sine wave. In such embodiments, a top of the plurality of tops, especially a plurality of tops, may have a protruding part protruding relative to the sine wave in a direction away from the central plane. Similarly, in such embodiments, a valley of the plurality of valleys, especially a plurality of valleys, may have a shallow part receding relative to the sine wave in a direction to the central plane.

In further embodiments, the periodic structure may comprise a shape defined by a plurality of triangles. In further embodiments, the periodic structure may comprise a shape defined by a plurality of trapezoids.

In embodiments, the lamp screw cap may have a longitudinal (central) axis. In particular, the tops of the thread structure may be directed away from the longitudinal axis, whereas the valleys of the thread structure may be directed towards the longitudinal axis.

The thread structure may especially define one or more helices, especially wherein the helices turns around the longitudinal axis. In particular, the helices may define the tops and/or the valleys. In particular, the thread structure may define one or more top helices, especially a plurality of top helices, wherein the top helices define the tops. Similarly, the thread structure may define one or more valley helices, especially a plurality of valley helices, wherein the valley helices define the valleys.

In embodiments, the (top/valley) helices may especially turn around the longitudinal axis at a constant distance (between adjacent revolutions) while moving parallel to the axis.

In further embodiments, successive revolutions of the (top/valley) helices may have a constant diameter along at least part of a longitudinal length of the lamp screw cap, such as along at least 10% of the longitudinal length, such as along at least 20% of the longitudinal length, especially along at least 30% of the longitudinal length, such as along at least 50% of the longitudinal length, especially along at least 70% of the longitudinal length, such as along at least 80% of the longitudinal length.

In further embodiments, the revolutions of the (top/valley) helices may have a (continuously) varying diameter along at least part of a longitudinal length of the lamp screw cap, such as along at most 70% of the longitudinal length, especially along at most 50% of the longitudinal length, such as along at most 30% of the longitudinal length.

In embodiments, for the top, especially for each of the tops of the plurality of tops, the middle top segment has a middle top length MTL In further embodiments, for a top, especially for each of the tops of the plurality of tops, the first top segment and the second top segment (each) define (100%-MTL)/2 of the length of the top along the thread structure, especially along the periodic structure. In further embodiments, MTL may be selected from the range of up to 50%, such as from the range up to 45%, such as from the range of up to 40%, especially from the range of up to 35%, such as from the range of up to 30%, especially from the range of up to 25%, such as from the range of up to 20%, especially from the range of up to 15%.

In further embodiments, MTL may be selected from the range of at least 5%, especially at least 10%, such as at least 15%, especially at least 20%, such as at least 25%, especially at least 30%, such as at least 35%, especially at least 40%.

In further embodiments, for a top, especially for each of the tops of the plurality of tops, the first top segment and the second top segment (each) define (γ1m°-γ1)/2 of the top. In further embodiments, for the top, especially for each of the tops of the plurality of tops, the middle top segment defines γ1 of the top.

In particular, γ1m may be a circular arc corresponding to the first top segment and the second top segment. In embodiments, γ1m may, for example, be selected from the range of 150°-180°. In embodiments, the circular arc may especially be a semicircle. Hence, γ1m may especially be 180°. Hence, in further embodiments, the first top segment and the second top segment may (each) define (180°-γ1)/2 of the top.

In embodiments, γ1 may be selected from the range of up to 90°, especially from the range of up to 80°, such as from the range of up to 70°, especially from the range of up to 60°, such as from the range of up to 50°, especially from the range of up to 40°, such as from the range of up to 30°, especially from the range of up to 20°.

In further embodiments, γ1 may be selected from the range of at least 10°, such as at least 20°, especially at least 30°, such as at least 40°, especially at least 50°, such as at least 60°, especially at least 70°.

If γ1 (or MTL) is too large, it may be challenging, or even impossible, to screw the lamp screw cap into a lamp fitting designed for the periodic structure, such as for the first curvature. For example, if the thread structure corresponds to an E26 lamp screw cap, wherein the protruding parts are provided on tops of the thread structure of an E26 lamp screw cap, it may—if γ1 is too large—be challenging to screw the E26 lamp screw cap into an E26 lamp fitting, especially an E26 screw base.

Hence, γ1 may, for example, be selected from the range of 10°-60°.

Similarly, MTL may, for example, be selected from the range of 5%-35%.

In further embodiments, relative to central points on the central plane for each of the tops of the plurality of tops, the first top segments and the second top segments may (each) define (γ1m-γ1)/2 of the tops, respectively, and the middle top segments define γ1 of the tops, especially wherein γ1m=180°, and especially wherein γ1 is selected from the range of 10°-90°.

In further embodiments, for each top of (at least part of) the plurality of tops, γ1 may be independently selected from the range of 10°-90°.

In embodiments, for the valley, especially for each of the valleys of the plurality of valleys, the middle valley segment has a middle valley length MVL. In further embodiments, for a valley, especially for each of the valleys of the plurality of valleys, the first valley segment and the second valley segment (each) define (100%-MVL)/2 of the length of the valley along the thread structure, especially along the periodic structure. In further embodiments, MVL may be selected from the range of up to 50%, such as from the range up to 45%, such as from the range of up to 40%, especially from the range of up to 35%, such as from the range of up to 30%, especially from the range of up to 25%, such as from the range of up to 20%, especially from the range of up to 15%.

In further embodiments, MVL may be selected from the range of at least 5%, especially at least 10%, such as at least 15%, especially at least 20%, such as at least 25%, especially at least 30%, such as at least 35%, especially at least 40%.

In further embodiments, for a valley, especially for each of the valleys of the plurality of valleys, the first valley segment and the second valley segment (each) define (γ2m°-γ2)/2 of the valley. In further embodiments, for the valley, especially for each of the valleys of the plurality of valleys, the middle valley segment defines γ2 of the valley.

In particular, γ2m may be a circular arc corresponding to the first valley segment and the second valley segment. In embodiments, γ2m may, for example, be selected from the range of 150°−180°. In embodiments, the circular arc may especially be a semicircle. Hence, γ2m may especially be 180°. Hence, in further embodiments, the first valley segment and the second valley segment may (each) define (180°-γ2)/2 of the valley.

In embodiments, γ2 may be selected from the range of up to 90°, especially from the range of up to 80°, such as from the range of up to 70°, especially from the range of up to 60°, such as from the range of up to 50°, especially from the range of up to 40°, such as from the range of up to 30°, especially from the range of up to 20°.

In further embodiments, γ2 may be selected from the range of at least 10°, such as at least 20°, especially at least 30°, such as at least 40°, especially at least 50°, such as at least 60°, especially at least 70°.

Hence, γ2 may, for example, be selected from the range of 10°-90°, such as from the range of 10°-60°.

Similarly, MVL may, for example, be selected from the range of 5%-35%.

In further embodiments, relative to central points on the central plane for each of the valleys of the plurality of valleys, the first valley segments and the second valley segments may (each) define (γ2m-γ2)/2 of the valleys, respectively, and the middle valley segments define γ2 of the valleys, especially wherein γ2m=180°, and especially wherein γ2 is selected from the range of 10°-90°.

In further embodiments, for each valley of (at least part of) the plurality of valleys, γ2 may be independently selected from the range of 10°-90°. In embodiments wherein the first top segment and the second top segment have the same first curvature, the first top segment and the second top segment, may each define at least part of a semicircle (with radius of curvature r). Especially, the first top segment and the second top segment may (each) define at least 0.8*(γ1m-γ1)/2 of the (circular arc of the) semicircle, especially at least 0.9*(γ1m-γ1)/2 of the (circular arc of the) semicircle, such as at least 0.99*(γ1m-γ1)/2 of the (circular arc of the) semicircle, including (γ1m-γ1)/2 of the (circular arc of the) semicircle.

In embodiments wherein the first valley segment and the second valley segment have essentially the same first curvature, the first valley segment and the second valley segment, may each define at least part of a semicircle (with radius (r)). Especially, the first valley segment and the second valley segment may (each) define at least 0.8*(γ2m-γ2)/2 of the (circular arc of the) semicircle, especially at least 0.9*(γ2m-γ2)/2 of the (circular arc of the) semicircle, such as at least 0.99*(γ2m-γ2)/2 of the (circular arc of the) semicircle, including (γ2m-γ2)/2 of the (circular arc of the) semicircle.

In embodiments, the thread structure may comprise tops and/or valleys without protruding and/or shallow parts. Hence, in further embodiments, the thread structure may comprise smooth tops, wherein the smooth tops protrude relative to the central plane, and wherein for a plurality of smooth tops may apply that each smooth top comprises a single top segment, wherein the single top segment defines the smooth top, and wherein the single top segment has a constant first curvature. Similarly, in further embodiments, the thread structure may comprise smooth valleys, wherein the smooth valleys protrude relative to the central plane, and wherein for a plurality of smooth valleys may apply that each smooth valley comprises a single valley segment, wherein the single valley segment defines the smooth valley, and wherein the single valley segment has a constant first curvature.

As the tops and valleys may be part of top helices and valley helices, respectively, also the helices may be divided into helices with protruding parts and shallow parts, especially along at least 80% of the helix, and helices without protruding parts and shallow parts.

Hence, in embodiments, a top helix may define tops along the length of the top helix, especially wherein along at least 5% of the (length of the) top helix the tops have protruding parts, such as along at least 10% of the (length of the) top helix the tops have protruding parts, especially along at least 20% of the (length of the) top helix the tops have protruding parts 30% of the (length of the) top helix the tops have protruding parts, such as along least 50% of the top helix, especially along at least 80% of the top helix, such as along at least 99% of the top helix, including along 100% of the top helix.

Similarly, in further embodiments, a smooth top helix may define smooth tops along the length of the smooth top helix, especially along at least 80% of the smooth top helix, such as along at least 99% of the smooth top helix, including along 100% of the smooth top helix.

Hence, in further embodiments, the thread structure may comprise a top helix and a smooth top helix.

Similarly, in embodiments, a valley helix may define valleys along the length of the valley helix, especially wherein along at least 5% of the (length of the) valley helix the valleys have protruding parts, such as along at least 10% of the (length of the) valley helix the valleys have protruding parts, especially along at least 20% of the (length of the) valley helix the valleys have protruding parts 30% of the (length of the) valley helix the valleys have shallow parts, such as along least 50% of the valley helix, especially along at least 80% of the valley helix, such as along at least 99% of the valley helix, including along 100% of the valley helix.

Similarly, in further embodiments, a smooth valley helix may define smooth valleys along the length of the smooth valley helix, especially along at least 80% of the smooth valley helix, such as along at least 99% of the smooth valley helix, including along 100% of the smooth valley helix.

Hence, in further embodiments, the thread structure may comprise a valley helix and a smooth valley helix.

Further, in embodiments, the value of MTL may (gradually) vary along the top helix. In further embodiments, the value of MTL may (essentially) be constant along the top helix, such as constant along at least 80% of the (length of the) top helix.

Similarly, in further embodiments, the value of MVL may (gradually) vary along the valley helix. In further embodiments, the value of MVL may (essentially) be constant along the valley helix, such as constant along at least 80% of the (length of the) valley helix.

Further, in embodiments, the value of γ1 may (gradually) vary along the top helix. In further embodiments, the value of γ1 may (essentially) be constant along the top helix, such as constant along at least 80% of the (length of the) top helix.

Similarly, in further embodiments, the value of γ2 may (gradually) vary along the valley helix. In further embodiments, the value of γ2 may (essentially) be constant along the valley helix, such as constant along at least 80% of the (length of the) valley helix.

In embodiments, one or more protruding parts may comprise a top ridge. The top ridge may have a (top) ridge top directed away from the central plane. In particular, the top ridge may taper away from the central plane. In further embodiments, the top ridge may have a top ridge length TRL defined perpendicular to the central plane and a top ridge width TRW defined parallel to the central plane, especially parallel to the longitudinal axis of the lamp screw cap, wherein 1.2≤TRL/TRW, such as 1.5≤TRL/TRW, especially 2≤TRL/TRW. In further embodiments, TRL/TRW≤10.

In further embodiments, the one or more protruding parts or top ridge may define the middle top segment, especially wherein γ1 is selected from the range of up to 30°.

Embodiments comprising a top ridge may be particularly beneficial with regards to the vibration strength of the lamp screw cap (when screwed into a lamp fitting). In particular, the top ridge may be more beneficial than a smooth protruding part.

Similarly, in embodiments, one or more protruding parts may comprise a valley ridge. The valley ridge may have a (valley) ridge top directed to the central plane. In particular, the valley ridge (top) may taper to the central plane. In further embodiments, the valley ridge may have a valley ridge length VRL defined perpendicular to the central plane and a valley ridge width VRW defined parallel to the central plane, especially parallel to the longitudinal axis of the lamp screw cap, wherein 1.2≤VRLNRW, such as 1.5≤VRLNRW, especially 2≤VRLNRW. In further embodiments, VRLNRW≤10.

In further embodiments, the one or more valley parts or valley ridge may define the middle valley segment, especially wherein γ2 is selected from the range of up to 30°.

In embodiments, the protruding parts may protrude relative to the periodic structure, especially relative to the first curvature, or especially relative to the semicircle, with a value selected from the range of 0.05-1.0 mm, such as from the range of 0.1-0.5 mm, especially from the range of 0.2-0.4 mm. Hence, the protruding parts may protrude relative to the periodic structure, especially relative to the first curvature, or especially relative to the semicircle, for a protrusion length, wherein the protrusion length is selected from the range of 0.05-1.0 mm, such as from the range of 0.1-0.5 mm, especially from the range of 0.2-0.4 mm.

In further embodiments, a top helix may define tops along the length of the top helix, wherein the protrusion length may be (essentially) the same along at least 30% of the (length of the) top helix, such as along least 50% of the top helix, especially along at least 80% of the top helix, such as along at least 99% of the top helix, including along 100% of the top helix. In further embodiments, the protrusion length may (gradually) vary along the top helix.

Similarly, in embodiments, the shallow parts may recede relative to the periodic structure, especially relative to the first curvature, or especially relative to the semicircle, with a value selected from the range of 0.05-1.0 mm, such as from the range of 0.1-0.5 mm, especially from the range of 0.2-0.4 mm. Hence, the shallow parts may recede relative to the periodic structure, especially relative to the first curvature, or especially relative to the semicircle, for a recession length, wherein the recession length is selected from the range of 0.05-1.0 mm, such as from the range of 0.1-0.5 mm, especially from the range of 0.2-0.4 mm.

In further embodiments, a valley helix may define valleys along the length of the valley helix, wherein the recession length may be (essentially) the same along at least 30% of the (length of the) valley helix, such as along least 50% of the valley helix, especially along at least 80% of the valley helix, such as along at least 99% of the valley helix, including along 100% of the valley helix. In further embodiments, the recession length may (gradually) vary along the valley helix.

In embodiments, the first curvature c₁ may be defined by a radius of curvature r, i.e., the (value of the) first curvature c₁ may be the reciprocal of the radius of the circle that best approximates the curve of the thread structure (at a specific point).

Hence, in embodiments, the first curvature may be defined by a radius of curvature (r), especially wherein the radius of curvature is selected from the range of 1-5 mm, such as from the range of 1.5-2.5 mm. In embodiments, the radius of curvature may be at least 1.5 mm, such as at least 1.6 mm, especially at least 1.7 mm, such as at least 1.8 mm, especially at least 1.9 mm. In further embodiments, the radius of curvature may be at most 2.5 mm, such as at most 2.4 mm, especially at most 2.3 mm, such as at most 2.2 mm, especially at most 2 mm, such as at most 1.9 mm.

The phrases “protruding relative to the first curvature” and “receding relative to the first curvature” may herein especially refer to protruding (receding) relative to a circular segment defined by the first curvature.

In embodiments, one or more of the shallow parts may comprise a planar valley part, especially wherein a second curvature c₂ of the planar valley part is at most 0.2*c₁, such as at most 0.1*c₁, especially at most 0.01*c₁, including 0. Hence, (at least part of) the middle valley segment may (essentially) be flat.

In particular, in embodiments, two shallow parts at opposite sides of the lamp screw cap may each comprise a planar valley part. In such embodiments, the two shallow parts at opposite sides may together define a substantially cylindrical shape, wherein the planar valley parts define the bases of the cylindrical shape.

The planar valley parts may substantially improve the vibration strength of the lamp screw cap to a lamp fitting interface (when connected to a lamp fitting). In particular, the planar valley parts may be more advantageous for the vibration strength than a valley ridge and than a shallow part with a larger first curvature.

The lamp screw cap of the invention may be particularly beneficial for larger screw caps, as an increase of vibration strength may be particularly beneficial for relatively heavy lamps. Hence, in embodiments, the lamp screw cap may be an E26 screw cap or larger, especially an E27 screw cap or larger.

In a second aspect, the invention may provide a lamp comprising a light source and the lamp screw cap according to any one of the preceding claims. The lamp may especially comprise a light bulb.

The lamp may have the benefit that it may have an improved vibration strength (when inserted into a lamp fitting).

The term “light source” may herein refer to an element that, during operation, emits light source light. In particular, the light source may be a light source that during operation emits at least (light source) light at a wavelength selected from the range of visible light, such as from the range of 380-780 nm.

The lamp screw cap of the invention may be particularly beneficial for heavy lamps, as an increase of vibration strength may be particularly beneficial for heavy lamps. Hence, in embodiments, the lamp may have a weight of 100 g or more, such as 120 g or more, especially 150 g or more, such as 200 g or more, especially 300 g or more.

In embodiments, the lamp, especially the light source, may comprise a solid state light source. In further embodiments, the lamp may comprise a driver, especially wherein the driver is functionally coupled to the solid state light source. In further embodiments, the light source may especially comprise at least 20 solid state light sources.

In further embodiments, the lamp may be a 80 W or larger (“larger” i.e. more power) lamp, especially a 100 W or larger lamp, such as a 120 W or larger lamp.

In a further aspect, the invention may provide a street lamp comprising a pole and the lamp as described herein, especially wherein the lamp (with lamp screw cap) is functionally coupled to the pole.

In a further aspect, the invention may provide a lamp fitting comprising a thread structure. The thread structure may comprise repetitive elements defining tops and valleys. The thread structure may further define a (virtual) central plane, especially wherein tops protrude relative to the central plane and wherein the valleys are recessed relative to the central plane. In particular, in a cross-sectional view of the thread structure, especially parallel to a longitudinal dimension of the lamp fitting, the tops may protrude relative to the central plane and the valleys may be recessed relative to the central plane.

In embodiments, for a plurality of tops may apply that each top comprises a first top segment, a second top segment, and a middle top segment. The first top segment, the second top segment and the middle top segment may especially together define the top. In particular, the middle top segment may be configured most remote from the central plane.

Similarly, in embodiments, for a plurality of valleys may apply that each valley comprises a first valley segment, a second valley segment, and a middle valley segment. The first valley segment, the second valley segment and the middle valley segment may especially together define the valley. In particular, the middle valley segment may be configured most remote from the central plane.

In embodiments, in a cross-sectional view an outline of the thread structure has a shape approximating a periodic structure. The periodic structure may have a regular periodicity and a regular amplitude with respect to the central plane. In further embodiments, one or more of the first top segment, the second top segment, the first valley segment, and the second valley segment may define at least part of the periodic structure. Especially, the first top segment, the second top segment, the first valley segment, and the second valley segment may (all) define at least part of the periodic structure.

In embodiments, one or more of the following may apply: (i) the plurality of tops have a protruding part, especially a protruding part protruding relative to the periodic structure in a direction away from the central plane; and (ii) the plurality of valleys have a shallow part, especially a shallow part receding relative to the periodic structure in a direction to the central plane.

Hence, in specific embodiments, the invention provides a lamp fitting comprising a thread structure, wherein the thread structure comprises repetitive elements defining tops, valleys, and a central plane, wherein tops protrude relative to the central plane and wherein the valleys are recessed relative to the central plane, wherein: for a plurality of tops may apply that each top comprise a first top segment, a second top segment, and a middle top segment, together defining the top, wherein the middle top segment is configured most remote from the central plane; for a plurality of valleys may apply that each valley comprise a first valley segment, a second valley segment, and a middle valley segment, together defining the valley, wherein the middle valley segment is configured most remote from the central plane; in a cross-sectional view an outline of the thread structure has a shape approximating a periodic structure with a regular periodicity and amplitude, and wherein the first top segment, the second top segment, the first valley segment, and the second valley segment define at least part of the periodic structure; one or more of the following may apply: (i) the plurality of tops have a protruding part protruding relative to the periodic structure in a direction away from the central plane; and (ii) the plurality of valleys have a shallow part receding relative to the periodic structure in a direction to the central plane.

In particular, the thread structure may have a shape defined by circle segments, especially circle segments with constant radii, such as by a plurality of (connected) semicircles. Hence, in specific embodiments, the invention may provide a lamp fitting comprising a thread structure, wherein the thread structure comprises repetitive elements defining tops, valleys, and a (virtual) central plane, wherein tops protrude relative to the central plane and wherein the valleys are recessed relative to the central plane, wherein: for a plurality of tops may apply that each top comprises a first top segment, a second top segment, and a middle top segment, together defining the top, wherein the middle top segment is configured most remote from the central plane; for a plurality of valleys may apply that each valley comprise a first valley segment, a second valley segment, and a middle valley segment, together defining the valley, wherein the middle valley segment is configured most remote from the central plane; the first top segment, the second top segment, the first valley segment, the second valley segment, have the same first curvature; one or more of the following may apply: the plurality of tops have a protruding part protruding relative to the first curvature in a direction away from the central plane; and the plurality of valleys have a shallow part receding relative to the first curvature in a direction to the central plane.

In a further aspect, the invention may further provide a process for the production of the lamp screw cap according to the invention.

In embodiments, the method may comprise providing the thread structure including the protruding parts.

In further embodiments, the method may comprise providing the thread structure including the receding parts.

In further embodiments, the method may comprise providing the thread structure without the receding parts and applying a force to one or more of the valleys to provide one or more receding parts.

In a further aspect, the invention may provide a lighting device comprising the lamp according to the invention. The lighting device may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, green house lighting systems, horticulture lighting, etc.

In a specific embodiment, the light source comprises a solid state LED light source (such as a LED or laser diode).

The term “light source” may also relate to a plurality of light sources, such as 2-20 (solid state) LED light sources. Hence, the term LED may also refer to a plurality of LEDs.

The invention is not limited to solid state light sources as example of light sources, but may also include e.g. high pressure light sources or other types of light sources known to the person skilled in the art.

In embodiments, the lamp may be configured to generate lamp light, such as white lamp light. However, other embodiments may also be possible.

The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL. The terms “visible”, “visible light” or “visible emission” refer to light having a wavelength in the range of about 380-780 nm.

The embodiments described herein are not limited to a single aspect of the invention. For example, an embodiment describing the thread structure with respect to the lamp screw cap may, for example, also apply to the lamp fitting, particularly to the thread supply of the lamp fitting. Similarly, an embodiment of the lamp screw cap describing the radiation, such as the donor excitation radiation or the acceptor emission radiation, may, for example, further apply to the method.

Further, instead of the term “lamp screw cap” also the term “screw cap” may be applied. The lamp screw cap may be used for a lamp, but may also be used for other applications, like e.g. a sensor, a heater, a cooler, a fan, etc.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-C schematically depict embodiments of the lamp screw cap.

FIG. 2 schematically depicts an embodiment of a lamp.

FIG. 3A-B schematically depict embodiments of a street lamp. The schematic drawings are not necessarily on scale.

### DETAILED DESCRIPTION OF THE EMBODIMENTS

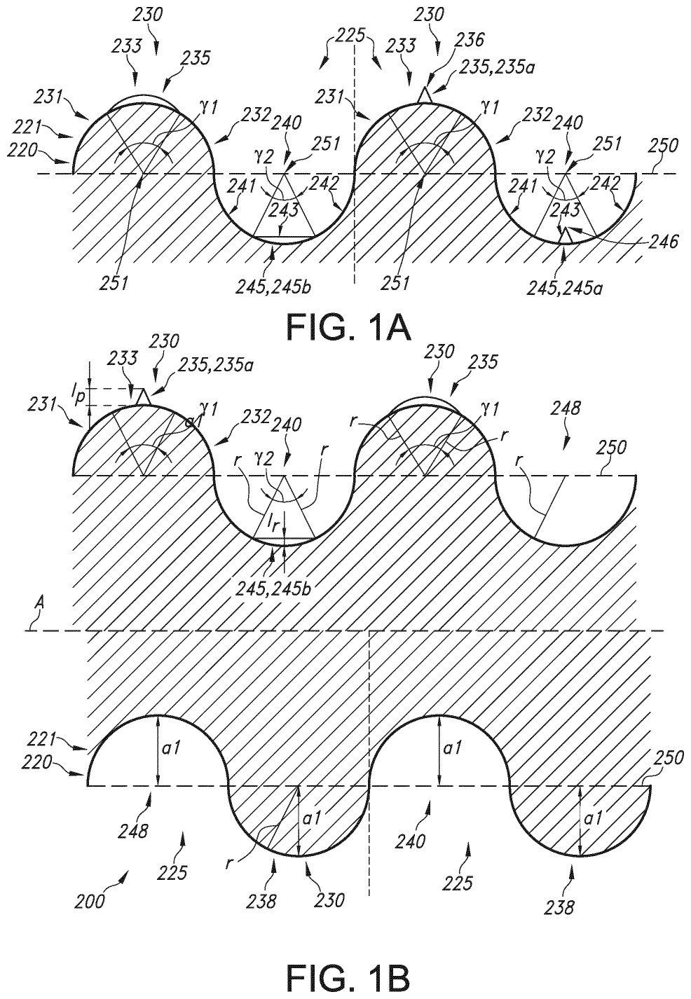

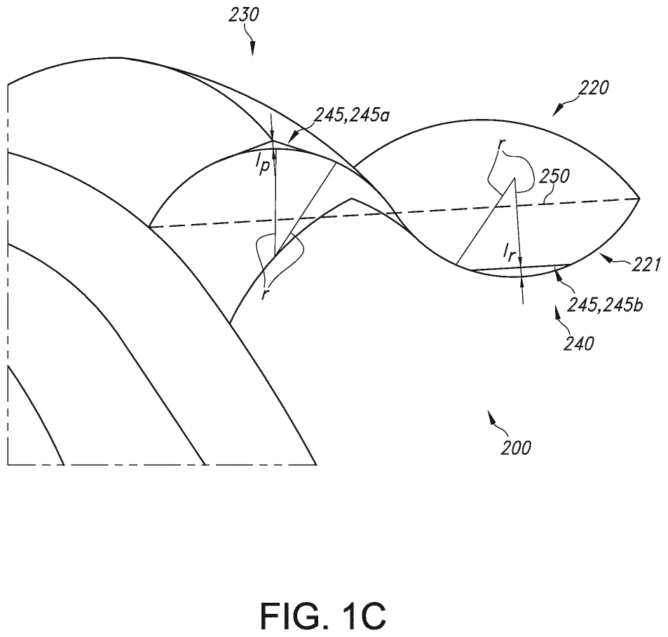

FIG. 1A-C schematically depicts embodiments of a lamp screw cap 200 comprising a thread structure 220.

In particular, FIG. 1A schematically depicts an outline of the thread structure 220 of an embodiment of the lamp screw cap 200. In the depicted embodiment, the thread structure 220 comprises repetitive elements 225 defining tops 230, valleys 240, and a central plane 250, wherein tops 230 protrude relative to the central plane 250 and wherein the valleys 240 are recessed relative to the central plane 250 (also see FIG. 1B). For a plurality of tops 230 applies that each top 230 may comprise a first top segment 231, a second top segment 232, and a middle top segment 233, wherein the middle top segment 233 is configured most remote from the central plane 250. The first top segment 231, the second top segment 232 and the middle top segment 233 may together define the top 230. Similarly, for a plurality of valleys 240 applies that each valley 240 may comprise a first valley segment 241, a second valley segment 242, and a middle valley segment 243, wherein the middle valley segment 243 is configured most remote from the central plane 250. The first valley segment 241, the second valley segment 242, and the middle valley segment 243 may together define the valley 240. In the depicted embodiment, the first top segment 231, the second top segment 232, the first valley segment 241, and the second valley segment 242, have the same first curvature.

In embodiments, the plurality of tops 230 may have a protruding part 235 protruding relative to the first curvature in a direction away from the central plane 250.

In further embodiments, the plurality of valleys 240 may have a shallow part 245 receding relative to the first curvature in a direction to the central plane 250.

For visualizational purposes, the radius of curvature r that corresponds to the first curvature is schematically depicted. Specifically, the first curvature may be defined by a radius of curvature r, i.e., the (value of the) first curvature may be the reciprocal of the radius r of the circle that best approximates the curve of the thread structure (at a specific point).

In the depicted embodiment, the plurality of tops 230 have a protruding part 235 protruding relative to the first curvature in a direction away from the central plane 250, and the plurality of valleys 240 have a shallow part 245 receding relative to the first curvature in a direction to the central plane 250.

In the depicted embodiment, the thread structure 220 has a shape defined by a plurality of connected semicircles with (equal) curvature, especially a continuous plurality of semicircles with curvature, wherein adjacent semicircles are arranged at opposite sides of the central plane 250.

In the depicted embodiment, relative to central points 251 on the central plane 250 for each of the tops 230 of the plurality of tops 230, the first top segments 231 and the second top segments 232 define 180°-γ1/2 of the tops 230, respectively, and the middle top segments 233 define γ1 of the tops 230, wherein γ1 is selected from the range of up to 90°.

The central points 251 of the central plane 250 may especially be—as depicted in FIG. 1A—the points along the central plane having the highest (local) distance between the central plane and the thread structure. In particular, the central points 251 of the central plane 250 may especially be the centers of the circular arcs, especially the centers of the semicircles.

Further, in the depicted embodiment, relative to central points 251 on the central plane 250 for each of the valleys 240 of the plurality of valleys 240, the first valley segments 241 and the second valley segments 242 define 180°-γ2/2 of the valleys 240, respectively, and the middle valley segments 243 define γ2 of the tops 230, wherein γ2 is selected from the range of up to 90°.

In the depicted embodiment, one of the protruding parts 235 comprises a top ridge 235a, wherein the top ridge 235a is directed away from the central plane 250. Similarly, in the depicted embodiment, one of the shallow elements 245 comprises a valley ridge 245a, wherein the valley ridge 245a is directed to the central plane 250.

Further, in the depicted embodiment, one or the shallow parts 245 comprises a planar valley part 245b. In embodiments, the planar valley part 245b may (essentially) be parallel to the central plane 250.

In the depicted embodiment, a shallow part 245 may define the (respective) middle valley segment 243. In particular, a valley ridge 245a may define the (respective) middle valley segment 243, or a planar valley part 245b may define the middle valley segment 243.

FIG. 1B schematically depicts (part of) a cross-sectional view of an embodiment of a lamp screw cap 200.

In the depicted embodiment, the thread structure 220 comprises a top 230 having a protruding part 235 as well as a smooth top 238, wherein the smooth top 238 has a constant first curvature. Similarly, the thread structure 220 comprises a valley 230 having a shallow part 245 as well as a smooth valley 248, wherein the smooth valley 248 has a constant first curvature.

In the depicted embodiment, the thread structure 220 further comprises a top 230 having a protruding part 235, wherein the protruding part is a top ridge 235,235a, wherein the top ridge 235, 235a has a top ridge top 236 directed away from the central plane 250.

Similarly, one or more of the shallow parts 245 may comprise a valley ridge 245a, wherein the valley ridge 245a has a (valley) ridge top 246 directed to the central plane 250.

In the depicted embodiment, the thread structure has a shape approximating a periodic structure 221, wherein the periodic structure 221 is defined by connected semicircles, wherein adjacent semicircles are arranged at opposite sides of the central plane 250. In particular, the periodic structure 221 may have a constant amplitude a1, and a constant periodicity (here provided by the repeating elements 225). In further embodiments, the periodic structure 221 may be defined by a sine wave.

In the depicted embodiment, the amplitude a1 may be equal to the radius of curvature r as the depicted thread structure 220 approximates a periodic structure 221 defined by semicircles. In further embodiments the thread structure may approximate a periodic structure defined by circular segments having an arc <180°, i.e., in further embodiments a1<r.

FIG. 1B further schematically depicts a longitudinal axis A of the lamp screw cap 200.

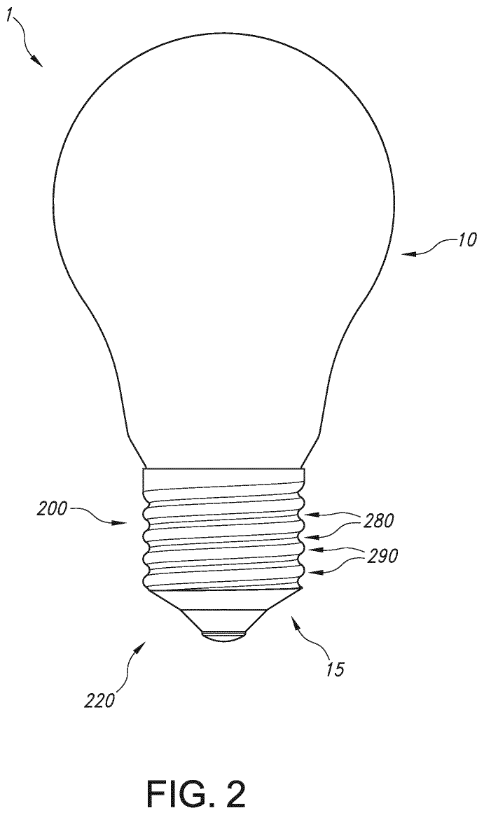

FIG. 1B schematically depicts two periodic structures 221 arranged at opposite sides of the lamp screw cap 200. In the depicted embodiment, the two opposite periodic structures 221 are depicted slightly “out of phase”, in order to stress the helical arrangement of the repetitive structures. Hence, in embodiments, the two opposite periodic structures 221 may be out of phase (also see FIG. 2), especially 180° out of phase. However, in further embodiments, the opposite periodic structures may also be in phase.

As shown in FIG. 1B, the central plane 250 may essentially divide the valleys 240 and the tops 230, with the former at one side of the central plane 250, and the latter at the other side of the central plane. In particular, with respect to a lamp screw cap 200, the different cross-sections may each provide a respective central plane 250, wherein the central planes 250 may together define a virtual cylinder from which the tops 230 of the thread structure 220 protrude and into which the valleys 240 of the thread structure 220 recess.

FIG. 1B further schematically depicts that the protruding parts 235 may protrude relative to the periodic structure 220, especially relative to the first curvature, or especially relative to the semicircle, for a protrusion length lₚ, wherein the protrusion length lₚ is selected from the range of 0.05-1.0 mm, such as from the range of 0.1-0.5 mm, especially from the range of 0.2-0.4 mm. Similarly, in the depicted embodiment, the shallow parts 245 may recede relative to the periodic structure 220, especially relative to the first curvature, or especially relative to the semicircle, for a recession length lᵣ, wherein the recession length is selected from the range of 0.05-1.0 mm, such as from the range of 0.1-0.5 mm, especially from the range of 0.2-0.4 mm.

FIG. 1C schematically depicts an embodiment of the lamp screw cap 200. In the depicted embodiment, the outline of a periodic structure 221 defined by circular segments with radius of curvature r is drawn. In particular, the depicted thread structure 220 approximates a periodic structure 221 defined by circular segments having an arc <180°. FIG. 1C further schematically depicts a protruding part 235 protruding relative to the first curvature in a direction away from the central plane 250, wherein the protruding part comprises a top ridge 235a. FIG. 1C further schematically depicts a shallow part 245 receding relative to the first curvature in a direction to the central plane 250, wherein the shallow part 245 comprises a planar valley part 245b.

FIG. 2 schematically depicts an embodiment of the lamp 1 of the invention. The lamp may comprise a light source 10 and the lamp screw cap 200 according to the invention.

In embodiments, the lamp 1, especially the light source 10, may comprise a solid state light source 10 and a driver 15 (here depicted arranged inside the lamp screw cap 200).

In the depicted embodiment, the lamp screw cap 200, especially the thread structure, comprises a plurality of top helices 290 and valley helices 280. The top helices 290 and the valley helices 280 may especially spiral along a longitudinal axis A of the lamp screw cap 200 (See FIG. 1B).

In particular, a top helix 290 may define tops 230 along the length of the top helix 290, especially wherein along at least 30% of the (length of the) top helix 290 the tops 230 have protruding parts 235, such as along least 50% of the top helix 290, especially along at least 80% of the top helix 290, such as along at least 99% of the top helix 290, including along 100% of the top helix 290.

Similarly, in further embodiments, a smooth top helix may define smooth tops 238 along the length of the smooth top helix, especially along at least 80% of the smooth top helix, such as along at least 99% of the smooth top helix, including along 100% of the smooth top helix.

Hence, in further embodiments, the thread structure 220 may comprise a top helix 290 and a smooth top helix.

Similarly, in embodiments, a valley helix 280 may define valleys along the length of the valley helix 280, especially wherein along at least 30% of the (length of the) valley helix 280 the valleys 240 have shallow parts 245, such as along least 50% of the valley helix 280, especially along at least 80% of the valley helix 280, such as along at least 99% of the valley helix 280, including along 100% of the valley helix 280.

In further embodiments, a smooth valley helix may define smooth valleys 248 along the length of the smooth valley helix, especially along at least 80% of the smooth valley helix, such as along at least 99% of the smooth valley helix, including along 100% of the smooth valley helix.

Hence, in further embodiments, the thread structure 220 may comprise a valley helix 280 and a smooth valley helix.

In embodiments, the lamp screw cap 200 may be an E26 screw cap or larger. In further embodiments, the lamp may have a weight of 150 g or more.

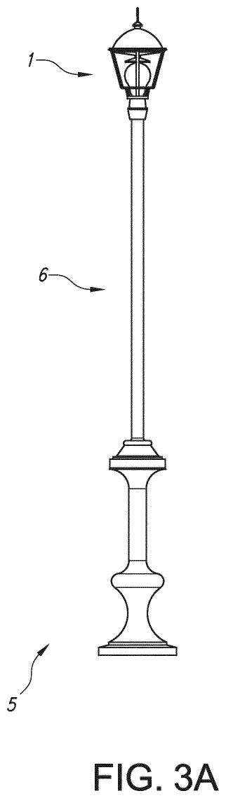

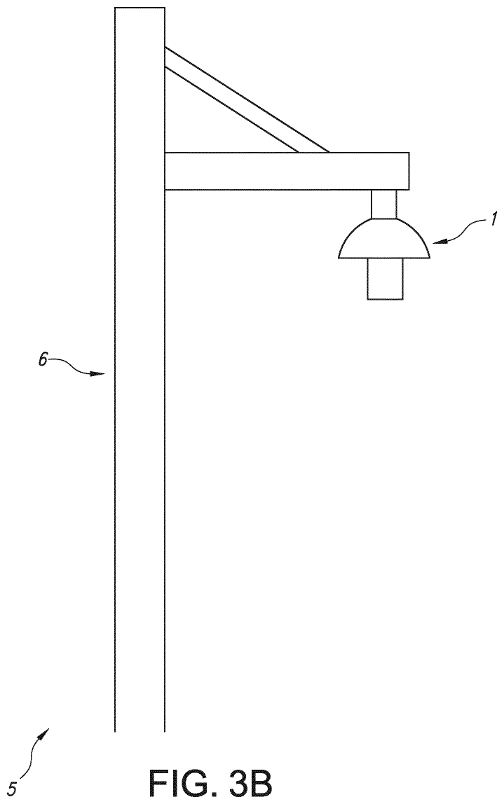

FIG. 3A-B schematically depict embodiments of a street lamp 5 comprising a pole 6 and the lamp 1 according to the invention.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment, but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lamp screw cap comprising a thread structure wherein the thread structure comprises repetitive elements defining tops, valleys, and a central plane, wherein tops protrude relative to the central plane and wherein the valleys are recessed relative to the central plane, wherein:
for a plurality of tops applies that each top comprises a first top segment, a second top segment, and a middle top segment, together defining the top, wherein the middle top segment is configured most remote from the central plane;
for a plurality of valleys applies that each valley comprises a first valley segment, a second valley segment, and a middle valley segment, together defining the valley wherein the middle valley segment is configured most remote from the central plane;
the first top segment, the second top segment, the first valley segment, and the second valley segment, have the same first curvature; and
wherein the following applies:
the plurality of tops have a protruding part protruding relative to the first curvature in a direction away from the central plane; and
the plurality of valleys have a shallow part receding relative to the first curvature in a direction to the central plane.

2. The lamp screw cap according to claim 1, wherein one or more of the following applies:
relative to central points on the central plane for each of the tops of the plurality of tops, the first top segments and the second top segments define (180°-γ1)/2 of the tops, respectively, and the middle top segments define γ1 of the tops, wherein γ1 is selected from the range of up to 90; and
relative to central points on the central plane for each of the valleys of the plurality of valleys, the first valley segments and the second valley segments define (180°-γ2)/2 of the valleys, respectively, and the middle valley segments define γ2 of the tops, wherein γ2 is selected from the range of up to 90°.

3. The lamp screw cap according to claim 1, wherein one or more protruding parts comprise a top ridge.

4. The lamp screw cap according to claim 2, wherein the one or more protruding part define the one or more middle top segments, wherein γ1 is selected from the range of up to 30°.

5. The lamp screw cap according to claim 1, wherein (a) the protruding parts protrude relative to the first curvature with a value selected from the range of 0.1-0.5 mm, or (b) the shallow parts recede relative to the first curvature with a value selected from the range of 0.1-0.5 mm.

6. The lamp screw cap according to claim 1, wherein one or more of the shallow parts comprise a valley ridge, with a valley ridge top directed to the central plane.

7. The lamp screw cap according to claim 1, wherein one or more of the shallow parts; comprise a planar valley part.

8. The lamp screw cap according to claim 1, wherein the first curvature is defined by a radius of curvature, wherein the radius of curvature is selected from the range of 1.5-2.5 mm.

9. The lamp screw cap according to claim 1, wherein the one or more shallow parts define the one or more middle valley segments, wherein γ2 is selected from the range of 10-60°.

10. A lamp comprising a light source and the lamp screw cap according to claim 1.

11. The lamp according to claim 10, wherein the lamp screw cap is an E26 screw cap or larger.

12. The lamp according to claim 10, wherein the lamp comprises a solid state light source and a driver.

13. The lamp according to claim 10, wherein the lamp has a weight of 150 g or more.

14. A street lamp comprising a pole and the lamp according to claim 10 functionally coupled to the pole.

15. A process for the production of the lamp screw cap according to claim 1, wherein the method comprises one or more of:
providing the thread structure including the protruding parts; and the receding parts;
providing the thread structure including the protruding parts and without the receding parts and applying a force to one or more of the valleys to provide one or more receding parts.
